(19) United States
(12) Patent Application Publication
(10) Pub. No.: US 2008/0244699 A1
(43) Pub. Date: Oct. 2, 2008

(54) IDENTIFICATION MEANS AND METHOD FOR THE LOGICAL AND/OR PHYSICAL ACCESS TO A TARGET MEANS

(75) Inventors: Stefan Parhofer, Munich (DE); Bernd Dietel, Aurach (AT); Dipl-Ing Bernd Lind, Herrsching (DE)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Armatix GmbH, Unterfohring (DE)

(21) Appl. No.: 11/955,833

(22) Filed: Dec. 13, 2007

(30) Foreign Application Priority Data
Dec. 22, 2006 (EP) 06 02 6821.6

(51) Int. Cl. H04L 9/32

(52) U.S. Cl. 726/2

(57) ABSTRACT

A means for the secure personalized identifying and allowing or prohibiting of a logical and/or physical access to a target means. The means comprises a portable identification means for outputting an authorization signal comprising at least one biometric sensor, at least one output elemental, a processor having a memory and a software as well as a sending- and receiving electronic for the wireless data exchange. The identification medium is configured in such a manner that upon successfully authentifying by an authorized user, an authorization signal is output over the output element. The portable identification medium is arranged at a wristband to be fixed at a user's wrist. The means comprises at least one security means which is configured to interrupt and/or prohibit the outputting of the authorization signal in case the wristband is opened and/or disconnected and/or the removing of the means from the user's wrist.

The present invention relates to a method and a means for the secure personified identifying and the allowing or prohibiting of a logical and/or physical access to a target means. The present invention can be used besides the traditional access control particularly to buildings, particularly also in the range of electronically securing of weapons. Further applications known to the person skilled in the art, like the access to vehicles, safes etc., are preferred.

In the state of the art, it is known to secure a transponder biometrically, for example by a finger print sensor, against unauthorized access. Such a transponder can only be used by the authorized user. It is an advantage over a biometric scanner fixedly mounted to the target means, for example a door, that the biometric transponder does not require a wiring to the target means and that it can release an arbitrary number of target means.

DE-A-103 41 370, for example, discloses a system for the secure personified identifying and allowing or prohibiting a logical and/or physical access to a target means. Here, firstly the user is identified by a portable identification medium wherein biometrical data of the user are detected by a biometric sensor. After an authorized user has been successfully identified and the authorization of the identification medium or the signal sent has been checked by the counter station, a logical and/or physical access to a target means is allowed or prohibited.

WO-A-2005/054771 discloses a security means for handguns, which relates to a transponder for the authentifying of an authorized gun user, who wears the transponder, or the authentifying of an allowed area for using the gun. Thereby, the transponder is adapted to preferably output an encoded wireless authentification signal. Further, the security means provides securing measures when the gun is gripped, said securing means being adapted to be necessarily activated by the user's hand when the gun is gripped, where by the securing means outputs a wireless request signal. Here, the transponder is adjusted to output the authentification signal upon receipt of the request signal from the securing measures. The securing measures are further configured to receive and to process the authentification signal from the transponder, as well as to only allow the firing of the weapon by the user upon receipt of an authentification signal from the transponder, the signal authentifying an authorized user. According to WO-A-2005/054771, said transponder can be a ring or bracelet.

DE-A-100 18 369 discloses an apparatus for releasing a shot or a weapon wherein the triggering unit of the weapon is configured for securing the weapon against unauthorized used in such a manner that said triggering unit is only released if a transponder to be worn by the user and to be addressed by an electronic circuit of the weapon returns a valid license code. Here, the transponder is preferably configured as a chip and is inserted in a flat carrier like a known chip card.

US-A-54461812 relates to a security system for a firearm wherein the user wears a finger ring in which a transponder is accommodated. Said transponder is interrogated by a security means accommodated within the firearm.

US-A-2001/0032405 discloses a firearm having a security system in which the authorized user is, for example, identified by a transponder arranged within a finger ring. Alternatively, a transponder can also be arranged within a bracelet, sweatband or a uniform sleeve.

WO-A-00/65291 describes a control system for a gun which comprises a security means wherein a transponder is arranged in an identification element, for example a finger ring or a bracelet, in order to identify the authorized user.

WO-A-98/04880 relates to a device for securing guns as well as for securing and/or storing of articles, said device having a locking means and an identification means, wherein the identification means is configured for the wireless exchange of at least distinctive identification codes and comprises at least one sending and/or receiving unit related to an authorized user and a further identification means wherein the locking means is deactivated by the identification means when there is a distance or a distance range between the sending and/or receiving unit and the matching identification code of the sending and/or receiving unit of the user and the and/or the receiving unit of the identification means. According to a preferred embodiment, the sending and/or receiving unit is configured as a transponder which can be interchangeably inserted into a watch band.

The systems known from the prior art, as, for example, described in DE-A-103 41 370, allow a secure personalized identifying and allowing or prohibiting of a logical and/or physical access to a target unit. For this, however, it is necessary to check and verify the identification and the authorization of the user prior to each allowing or prohibiting of a logical and/or physical access to a target unit. This may prove to be awkward and unsatisfying for the user.

An identification means activated permanently or for a determined period of time proves to be disadvantageous against a potential abuse in that the means releases the weapon or allows the access for the unauthorized user, too, after the means has been activated by the authorized user singularly. This is also true for the configuration of the identification means as finger ring or bracelet as suggested by the prior art, since said configuration cannot prevent the identification means being stolen and used by the unauthorized user. Thus, there is a higher risk of an abuse of the means known from the prior art.

It is thus an object of the present invention to provide an improved means and method for the secure personalized identifying and allowing or prohibiting of a logical and/or physical access to a target means. Particularly, it is an object of the present invention to provide such a means as well as such a method having improved handling properties and increased user friendliness and simultaneously providing an improved security against unauthorized access.

This object is achieved by the features of the independent claims. The dependent claims describe preferred embodiments of the present invention.

Thus, on the one hand the present invention relates to a means for securely personalized identifying and allowing or prohibiting logical and/or physical access to a target means. Said means comprises a portable identification medium for outputting an authorization signal having at least one biometric sensor, at least one input element, at least one output element, a processor having a memory and a software as well as a sending and receiving electronic. Here, the identification medium is configured to output an authorization signal after successfully authentifying or identifying an authorized user. Such a signal can either be output permanently, intermittently, a single time or for n times immediately upon the successful identification or as a response to a respective request signal of a counter station. The portable identification medium is configured to be fixed to a wrist band or bracelet at the user's wrist.

The means further comprises a security means that is configured to interrupt, to prohibit and/or to deactivate the outputting of the authorization signal in case the wrist band or bracelet or the like is opened and/or the device is removed from the user's wrist. Preferably, as security means a contact switch or -ring is arranged at or on the down face facing the wrist. Further preferred, there is a battery arranged at or on the down face, which is enclosed by a preferably concentric metal ring so that the battery and the metal ring form a capacitor the capacity of which changes and triggers a switching function when the down face is removed from the user's wrist or skin. Alternatively or preferably additionally, the security means comprises a wrist band detector which is further preferred formed by an electric conductor arranged within or at the wrist band. Thereby, a part of the conductor can be integrated into the wrist band, for example can be woven into the band, and a further part of the conductor can be formed by the buckle. Preferably, the means is configured in such a manner that a new authentifying for outputting the authorization signal becomes necessary after the outputting of the authorization signal has been interrupted or prohibited or the identification medium has been deactivated by the security means.

Here, the term “opening of the wrist band” describes not only the conventional opening but also the violent pulling off or damaging the wrist band. Particularly, the security means ensures that the activating of the identification medium or the outputting of the authorization signal is only possible if the means according to the present invention is fixed to the authorized user's wrist by means of the wrist band or if the wrist band has not been opened since the last successful authentification of a user.

In the following, it is referred to an activating of the identification medium or an activated identification medium when an authorized use has been successfully identified and an authorization signal is output or can be output. Subsequently, it is referred to an inactivated or deactivated identification medium when no successful identification of an authorized user has taken place or when the identification medium has been deactivated by the security means.

Upon successfully identifying an authorized user, the identification medium is preferably activated for a period of time which can be selected, adjusted by the authorized user or which is fixedly predetermined.

The means according to the present invention preferably serves for the communication with a counter station, for example the locking means at a door, a security means, a weapon or the like, in a so called proximity modus which is explained in detail in the following.

Preferably, the means according to the present invention is configured in such a manner that the means or the activated identification medium authentifies itself upon a wake up or request signal sent by the counter station to the means, in turn of the authentification the counter station allows or prohibits the logical and/or physical access to a target means.

Preferably, the means is configured in such a manner that it is inactive or becomes deactivated when a predetermined distance to the counter station is exceeded. In the moment the means is again within the predetermined distance from the counter station, it is preferably re-activated or it becomes active again.

Preferably, the means becomes inactive when the activation period which has been predetermined or selected by the authorized user lapses. Here, a clock integrated into a wristwatch functions as time emitter.

According to a preferred embodiment, the means is arranged within the wristwatch or comprises further features like a time- and/or date display.

The means is preferably battery-operated. The means preferably comprises an antenna. The means is further preferred not entirely made of metal.

The means according to the present invention is preferably configured in such a manner that it can perform the method according to the present invention and the preferred embodiments of the method according to the present invention.

The present invention further relates to a method for the secure personalized identifying and allowing or prohibiting a logical and/or physical access to a target means. The method according to the present invention comprises the steps of identifying a user by means of a portable identification medium arranged at a wristband to be fixed at the user's wrist, whereby biometric data of at least one user are detected by at least one biometric sensor and data and/or orders are input over at least one input element and operating modes are displayed by at least one output element. Here, the detected geometric data are compared with the learnt data by means of a processor having a memory and a software, the processor comprising a decentral database being specific for the identification medium and comprising learnt geometric data. Upon successfully identifying an authorized user and depending on the permanent presence of additional security conditions an authorization signal is sent. In case the additional security conditions are no longer present or have been interrupted the identification medium is deactivated or the sending of an authorization signal is interrupted or prohibited.

Preferably, the additional security conditions are present when the wristband is closed and the identification medium is worn by a user while they are not present when the wristband is open or ruptured or not worn by a user.

Preferably, a new authentification for outputting an authorization signal anew is necessary after the outputting of an authorization signal has been interrupted or prohibited or the identification medium has been deactivated by the security means.

Preferably, the means according to the present invention can be remotely controlled, for example via satellite, or can send information to a satellite.

Preferably, the means, for example a watch, is additionally equipped with a GPS- or satellite sender and preferably covers at least one of the functions:
operation conditions, for a example of a weapon (the weapon was fired when by whom?), are transferred from the means to the satellite into a centre
the target means, for example a weapon, can be remotely released over the means, for example a watch
the target means, for example a weapon, can only be released at certain places by means of a GPS sender arranged within the target means.

Thus, it is possible to achieve an even higher administration level for the target means, for example a weapon.

In the following the further preferred embodiments of the present invention are described with reference to the attached Figures:

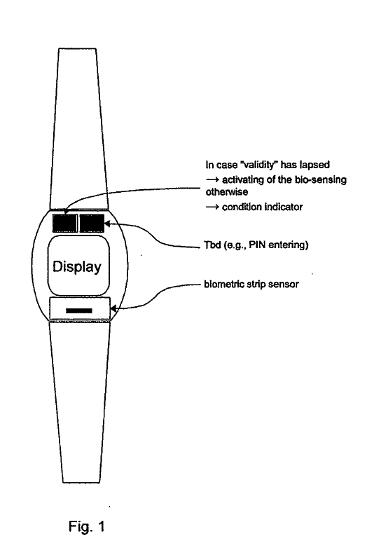

FIG. 1 shows a schematic drawing of a means according to the present invention;

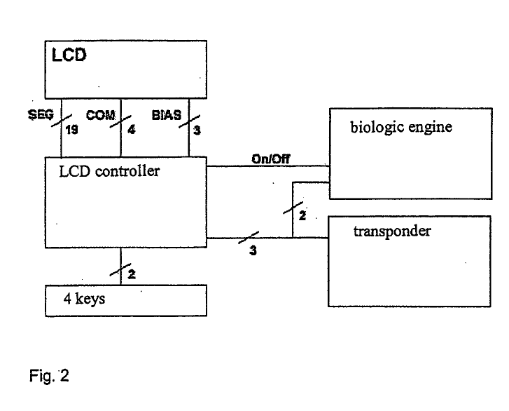

FIG. 2 shows schematically the structure of a means according to the present invention;

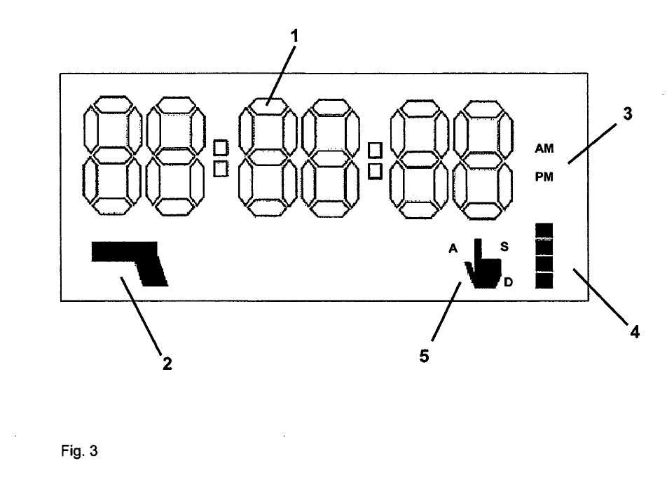

FIG. 3 shows a preferred output unit of a means according to the present invention;

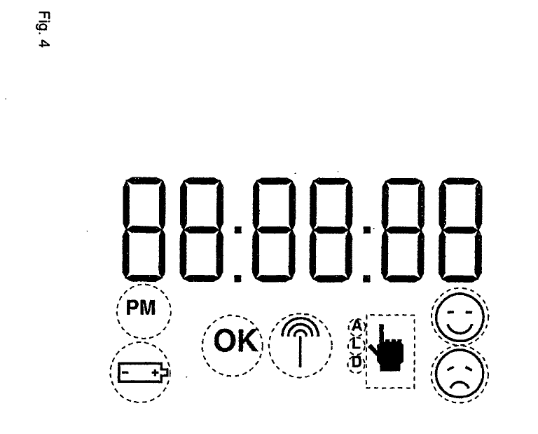

FIG. 4 shows a further embodiment of a preferred output unit of a means according to the present invention.

FIG. 1 shows a preferred embodiment 1 of the present invention having a biometric sensor in the form of a finger print strip sensor 2, an output element or a display unit 3, an input element 4 as well as a wrist band 5. The means according to the present invention further comprises a housing 6 for receiving the afore-mentioned elements as well as for fixing at the wrist band 5. Preferably, the biometric sensor or strip sensor 2 is positioned at the means 1 or the housing 6 in such a manner that a simple and accurate finger guiding is ensured. There are no prerequisites for the selection of the material for the housing. Preferably, the selection of the material for the housing is only limited in that the entire housing should not be made from metal allover in order to avoid dampening of the signal. The means according to the present invention comprises preferably input elements like the biometric sensor and preferably at least four, particularly preferred six keys. The keys serve for the adjusting of the means.

Preferably the means according to the present invention is configured in such a manner that the activating of the transponder or the identification medium is activated for a certain period which can be selected from the authorized user. During this period, the means according to the present invention can communicate with a counter station for example a locking unit or a weapon. Therefore, the counter station preferably sends a request- or wake-up signal to the means according to the present invention, the means authentificates itself and the counter station performs or initiates a predetermined action, for example, a door is opened, a gun is released or the access to a computer is allowed. As soon as the distance between the counter station and the means exceeds a predetermined preferably adjustable signal range the action or condition initiated by the counter station is deactivated again. Thus, for example the gun is again deactivated or secured. When the means and the counter station approach each other again so that the counter station is in the radio field or the signal range the releasing or action is repeated. For example, a gun can immediately be used again.

When the activation time has lapsed the user has to identify himself/herself with his/her finger print anew.

The adjusting of the means according to the present invention to a limited effect range is also referred to as proximity mode.

This can be entered by means of the input elements. Preferably, also the activation period, i.e. the time during which the transponder or the identification medium is activated after an identification of an authorized user, can be variably adjusted by the input elements. Depending on further functions provided by the means according to the present invention the input elements or keys preferably serve also for the adjusting of the time, date etc. In the first place, however, the input elements serve for a simple and secure operability of the biometric transponder function.

As output elements, the means according to the present invention preferably comprises a visual signal emitter (display, LED), an acoustic signal emitter (beeper, busser) and/or an RF interface (antenna, preferably arranged within the housing).

The means according to the present invention further comprises a security means. Preferably, the securing means is configured in such a manner that the wrist band is equipped with an electric conductor or contact. Thus, the means is capable to check whether the wrist band is closed. Preferably, a closed electric contact runs from the means through the wrist band and back to the means. According to a further preferred embodiment, the connecting points between housing of the wristband, wristband, i.e. buckle and wristband housing are provided with security measures. Thus, in case the wristband is opened, i.e. regularly opened at the buckle or pulled off, while the transponder is activated the transponder or the identification medium will automatically be deactivated.

Alternatively or additionally, means can be provided at the housing, the means being capable of monitoring the contact of the down face of the housing with the user's wrist and automatically deactivating the transponder when it is detected that the means is not arranged at a user's wrist.

Preferably, as security means a contact switch or -ring is provided at the down face facing the wrist. Further preferred, a battery is arranged at or on the down face, the battery being preferably enclosed by a concentric metal ring so that battery and metal ring form a capacitor, the capacity of which changes and which functions as a switch when the down face is removed from a user's wrist or skin.

The means according to the present invention is preferably battery operated.

The wireless communication between the electronic control unit of the security means and the external device can be performed in an arbitrary manner or at an arbitrary frequency which are suitable for the purpose of use, for example, low frequency (LF, e.g., 25 kHz with magnetic induction), radio frequency (RFID, e.g. 13.56 MHz) or high frequency (HF, e.g. 868 MHz, 915 MHz, 2.4 GHz or higher) and can be performed according to a standard protocol (e.g. blue tooth, ZigBee) or according to a protocol developed by the manufacturer or a combination of both. In this context, under the term “communication” any kind of a data exchange should be understood and can be encoded or non-encoded and either unidirectional or bidirectional. The person skilled in the art will select the suitable beginning and combination according to the desired properties of the system, e.g. optimizing of the signal range, transfer velocity, durability of the battery, costs or the sensitivity to external magnetic noise or other criteria. Either the control unit or the external device or both of them can comprise its/their own energy source. Said energy source can either be a battery, a fuel cell, a piezo-cell or a solar cell. In a further preferred embodiment both the control unit and the transponder comprise their own battery. In case either the control unit or the transponder does not comprise its own energy source, not only data but also energy are transferred via the wireless communication connection.

According to a preferred embodiment the means according to the present invention is configured to provide a securing for a gun. Such a securing for a gun preferably comprises two instances. The first instance is a counter station, preferably a transponder, arranged within the gun which is for example activated by a heel switch at the gun.

As second instance, the means according to the present invention which is worn at the wrist is used. The combination of the means according to the present invention and the counter station at the gun exclusively allows authorized persons the use of the gun. Therefore, the identification of an authorized person at the means according to present invention is achieved by detecting biometric data. The means according to the present invention preferably can further comprise additional functions, such as e.g. a time- and date display comparable with a conventional watch. Such a watch is preferably integrated as time emitter.

Prior to the use of the gun, it is necessary that an authorized person identifies itself for one time. For this purpose the finger print of said person is scanned by a sensor in the means according to the present invention and the means according to the present invention checks whether said person is authorized to use the gun. When the heel switch at the gun is operated the request for the release of the gun through the gun's transponder, i.e. the counter station, follows in the means according to the present invention. In case the request is preceded by a valid identification of an authorized person, the releasing is performed; in the other case it is denied. After releasing, the gun is armed or unsecured.

The connection distance between the gun's transponder, i.e., the counter station, and the means according to the present invention is held small. A communication between the gun's transponder and the means according to the present invention can only take place when the gun is hold in the hand on the wrist of which the means according to the present invention is worn. In case the gun comes out of the sending and receiving range of the means according to the present invention no new identification is necessary provided that the gun returns into the sending and receiving range within the activation period of the means according to the present invention. Said activation period can be adjusted user-specifically or fixedly. Additionally the wristband of the means according to the present invention comprises a sensor or at least one security means. In case the wristband is opened after the identification or the means according to the present invention is pulled from the user the identification lapses and/or the gun is deactivated, By this double securing, it is ensured that only authorized persons can use the gun. The use of a means according to the present invention for releasing a gun by an unauthorized person is effectively prevented even if an activated means is taken from an authorized user.

The functions of the means according to the present invention preferably cover the administration of finger prints, communication with the counter station, for example the gun's transponder, and/or the function of a digital watch.

The administration of finger prints preferably comprises the learning of finger prints, the acknowledging of learned finger prints and the deleting of learned finger prints. Preferably, two kinds of fingers are distinguished, i.e. the user- and administration fingers. Both the learning of new finger prints and the deleting of the entire data base can only be performed with the administration finger. For the communication between the user of the means according to the present invention and the biometric sensor preferably an LCD display is provided. Alternatively or additionally, also the communication via LED, for example red and green light and if necessary blinking light, is also preferred.

The communication functions preferably comprise the initializing of the communication protocol after the wake-up signal, negotiating a session key for the secure communication and/or the maintenance of an already existing communication. The communication is preferably realized as a point-to-point connection by means of a transponder. In order to maintain an already existing connection in an energy saving and simple manner the means according to the present invention preferably sends a periodic clock signal. In order to facilitate a secure communication, the counter station, e.g. the gun's transponder, and the means according to the present invention preferably negotiate a session key with which the clock signal is equipped.

A further communication function is the recording of the communication as well as actions of the gun. Thus, it is possible to memorize when the means of the present invention has been released by which user (finger print) and when and how often the gun has been released by the means according to the present invention. Furthermore, the gun can also transfer information like the operation data to the means according to the present invention, for example information concerning the number and time of fired shots, condition of the battery etc. provided that the gun comprises said functionality.

The clock functions preferably comprise the detecting of time and date, the adjusting of time and date, the adjusting of the displaying period of the LCD display, the selection between the 12- and 24-hour mode, the adjusting of the activation period of the transponder and/or a key combination by which the active transponder is deactivated in case of an emergency.

The means according to the present invention preferably has the schematic structure as shown in FIG. 2.

The LCD display is the communication interface between the means according to the present invention and the user. It displays information concerning proceedings within the means according to the present invention and displays, if necessary, the time and date. FIGS. 3 and 4 show preferred layouts of the LCD display.

The numeric display 7 particularly serves to display time and date. Additionally, it can be used for indicating the present number of templates when a new finger print is learned. Furthermore, the numeric display 7 indicate the entering of a PIN, if necessary.

Symbol 8 indicates whether the gun is armed. Upon successfully performing an identification and the gun being in the sending and receiving range of the means according to the present invention said symbol lights up. Optionally, said symbol 8 may additionally be blinking when the heel switch of the gun is operated.

Symbol 9 is only relevant when the 12-hour time mode is selected. In this case, the additional information is desirable whether the displayed time is in the morning (AM, ante meridiem) or in the evening (PM, post meridiem).

Symbol 10 is relevant in the finger print mode. It indicates the quality of the currently scanned finger print. There are 5 quality levels.

Symbol 11 is relevant in the finger print mode. The blinking hand symbol requests the finger to be scanned. The scanning of an administrator finger is indicated by the blinking of the hand symbol plus A. In case the hand symbol plus S blinks the scanning of the finger to be newly learned is requested. In case the hand symbol plus D blinks the user finger which should be deleted from the data base is requested. In case the administrator finger should be learned, this is indicated by the blinking hand symbol plus A plus S. This is the case for the first two fingers to be entered into the data base. The deleting of the entire data base is indicated by the blinking of the hand symbol plus A plus D. Additionally, a symbol combination is necessary which indicates that the scanning of the finger has been successful or not.

Preferably the display further comprises a transponder symbol (not shown in FIG. 3). This symbol serves to indicate whether the authentification has been successful independent of whether the gun is within the sending- and receiving range of the transponder watch. In order to save energy this symbol preferably is illuminated every 2 seconds for about 0.5 seconds. When the gun's transponder is within the sending- and receiving range of the means according to the present invention said symbol is permanently illuminated.

Preferably, it is possible to indicate via the LCD display the operation mode of the means according to the present invention.

Since the displaying of the time is of lower importance than the display for the administration of the finger prints and the communication with the gun's transponder, the numeric display is preferably relatively small compared with the displayed symbols. The transponder symbol is an important symbol and should therefore be well visible and eye catching.

The LCD controller (see FIG. 2) has a central position. All actions are coordinated by the LCD controller. Particularly, it serves for the control of the LCD display and the communication with the biometric sensor. Furthermore, it facilitates the key- and clock functions.

In a preferred embodiment of the means according to the present invention having a LCD controller the entire communication between user and means is controlled by the LCD controller. This includes the processing of the user's input over the four or six available keys and generating of output being displayed through the LCD display. The interconnection of the LCD controller with the biometric sensor and the transponder or the identification medium is preferably realized by means of an master-slave-architecture. Furthermore, the clock functions are implemented therein.

Preferably the LCD controller preferably comprises all operation modes necessary for the means according to the present invention.

The gun's transponder and the transponder clock are looked upon as communication partners since the transponder within the watch does not appear as proper unit during the communication.

When the heel switch is operated, the gun's transponder initiates the communication with the transponder watch by sending a wake-up signal. When the transponder watch receives said signal it checks whether a successful identifying of an authorized person has taken place. If this is not the case, it denies the communication. The gun does not get a releasing. Otherwise, the transponder watch queries the programming and the authorization. After the challenge response has been successfully completed the gun is released.

When the gun receives the releasing the communication with the transponder watch is maintained in that the transponder watch periodically sends a clock signal having an ACK signal.

By sending the clock signal it is possible to generate a protocol for each shot wherein preferably the integrated clock provides the clock signal.

In case the arrival of the clock signal at the gun's transponder or the arrival of the ACK signal at the transponder watch is delayed over a certain time-limit the communication is interrupted and the gun deactivated. In order to facilitate a secure communication both partners negotiate a session key.

In case the wristband of the transponder watch is opened, for example, violently the watch transponder is deactivated similar to when the transponder timer expires. Consequently, the transponder watch interrupts the communication and the gun is deactivated. Preferably, the transponder is not capable of receiving data. Upon successfully releasing the transponder preferably a periodical keep-alive signal having an interval of preferably about 500 milliseconds is sent. After an adjustable period of time has lapsed the sending of the keep-alive signal is stopped and, thus, the gun becomes inactive. This corresponds to the return of the LCD controller from the transponder activity mode into the display mode.

The securing of guns against misuse has nowadays a high importance in the community. The present invention provides a powerful system which can be easily handled, the system being able to securely and reliably prevent the abuse of guns by unauthorized persons.

1. A means for the secure personalized identifying and allowing or prohibiting of a logical and/or physical access to a target means, comprising;
a portable identification medium for outputting an authorization signal having
at least one biometric sensor,
at least one output element,
a processor with memory and software
as well as a sending- and receiving electronic for the wireless data exchange, wherein
the identification medium is configured to output an authorization signal over the output element upon a successful authentification of an authorized user, wherein
the portable identification medium is arranged at a wristband for fixing at a user's wrist, and wherein
the means comprises at least one security means, which is adapted to interrupt and/or to stop the outputting of an authorization signal in case the wristband has been opened and/or broken and/or removing of the means from the user's wrist.

2. The means according to claim 1, wherein the means is configured in such a manner that a new authentification is necessary before outputting the authorization signal anew after the output of the authorization signal has been interrupted or prohibited by the security means.

3. The means according to claim 1, wherein the identification medium further comprises at least one input element and is programmable.

4. The means according to claim 1 wherein the biometric sensor is a finger print sensor.

5. The means according to claim 1 wherein the biometric sensor is a biometric sensor working optically, capacitively, thermally or with radio waves.

6. The means according to claim 1 wherein the biometric sensor is an area- or strip sensor.

7. The means according to claim 1 wherein the input element is a key board preferably comprising at least 4, particularly preferred 6 keys.

8. The means according to claim 1 wherein the output element is an LED and/or display.

9. The means according to claim 1 wherein the identification medium can be wirelessly programmed.

10. The means according to claim 1 wherein the identification means is locally provided with energy or has a battery.

11. The means according to claim 1 wherein the processor of the identification medium comprises a decentral database with learned biometric data, said data base being specific for the identification medium.

12. The means according to claim 11, wherein the data base can be changed over the identification medium.

13. The means according to claim 1 wherein the security means comprise a contact switch and/or a wrist band detector, said means detecting the removing of the means from a user's wrist or the opening and/or disconnecting of the wrist band and interrupting and/or prohibiting the outputting of the authorization signal.

14. The means according to claim 13, wherein the contact switch is a capacitive switch preferably being formed by a battery at or on the down face of the means and a metal ring enclosing the battery.

15. The means according to claim 13 wherein the wristband detector is formed by an electric conductor within or at the wristband, the destruction of the electric conductor is detected by the security means.

16. The means according to claim 15, wherein a part of the conductor is integrated, e.g., woven in, in the wristband and a further part is formed by the buckle of the wristband.

17. The means according to claim 1, wherein the means is adapted to send or receive information, for example operation data, from or to the target means.

18. A wristwatch comprising the means according to claim 1.

19. A method for securely personalized identifying and allowing and/or prohibiting of a logical and/or physical access to a target means, particularly for operating a means according to claim 1 comprising the steps of:
identifying of a user by means of a portable identification medium arranged at a wristband to be fastened to the users wrist, wherein
biometric data of at least one user are detected by at least one biometric sensor and
operation conditions are displayed by at least one output element, and wherein
the detected biometric data are compared with the learned biometric data by means of a processor having a memory and a software, the processor comprising a decentral data base comprising learned biometric data and being specific for the identification medium;
sending of an authorization signal upon successfully identifying an authorized user either immediately or in response to a received request signal and depending on the permanent presence of additional security conditions, as well as
interrupting or prohibiting the sending of an authorization signal in case the presence of the additional security conditions has been interrupted.

20. The method according to claim 19, wherein the security conditions are present when the wristband is closed and the identification medium is worn by the user and said security conditions are not present in case the wristband is opened or interrupted or is not worn by the user.

21. The method according to claim 19, wherein it is necessary to perform a new authentification for sending an authorization signal anew when the sending of the authorization signal has been interrupted or prohibited by the security means.

22. The method according to claim 19, wherein the data base can be processed or changed over the identification medium in that further biometric data are learned, deleted and/or processed.

23. The method according to claim 19, wherein the detecting of biometric data is performed by means of a finger print sensor which detects the finger prints according to an optical and/or capacitive method.

24. The method according to claim 19, wherein the sensor works optically, capacitively, thermally or with radio waves.

25. The method according to claim 19, wherein the data and/or orders can be entered over at least one input element and the input is entered by means of a keyboard having preferably 4, particularly preferred 6 keys.

26. The method according to claim 19, wherein the outputting is performed by means of an LED and/or a display.

27. The method according to claim 19, wherein it is not only distinguished between authorized and unauthorized users but also between users having different authorizations or different levels of authorization.

28. The method according to claim 19, wherein the identification attempts and/or -proceedings are recorded by at least one of the processors.

29. The method according to claim 19, wherein it is necessary for identifying to additionally enter a correct PIN.

30. The method according to claim 19, wherein the user specific data stored in the data base are allocated to an hierarchy, wherein the identification medium only allows defined actions according to the hierarchy level of the identified user.
